(19) United States
(12) Patent Application Publication
(10) Pub. No.: US 2024/0107246 A1
(43) Pub. Date: Mar. 28, 2024

(54) STATE DETECTION FOR WEARABLE AUDIO DEVICES

(71) Applicant: Apple Inc., Cupertino, CA (US)

(72) Inventors: Tom-Davy W. SAUX, Los Gatos, CA (US); Champ DARABUNDIT, Seattle, WA (US); Martin E. JOHNSON, Los Gatos, CA (US); Victoria CHIU, San Jose, CA (US)

(21) Appl. No.: 18/239,718

(22) Filed: Aug. 29, 2023

Related U.S. Application Data
(60) Provisional application No. 63/409,653, filed on Sep. 23, 2022.

(51) Int. Cl. H04R 29/00

(52) U.S. Cl. CPC H04R 29/001; H04R 2430/20

(57) ABSTRACT

Aspects of the subject technology provide improved techniques for determining a state of an audio device, including reduced power techniques for determining if an earbud is currently being worn in a user's ear or not. In aspects, a potential state change in an audio device may be detected, and in response measurement of the state of the device may be initiated, such as by emitting an audio signal and then determining the state of the audio device based on a sensed version of the emitted audio signal.

### CROSS REFERENCE TO RELATED APPLICATIONS

This application claims the benefit of priority to U.S. Patent Application No. 63/409,653, entitled “State Detection For Wearable Audio Devices,” filed on Sep. 23, 2022, the disclosure of which is hereby incorporated herein in its entirety.

### TECHNICAL FIELD

The present description relates generally to personal audio devices.

### BACKGROUND

Media devices can communicate an audio signal to one or more audio accessories to playback audio. For example, a media device may select between one or more in-ear earphones when worn by a user during playback, or the media device can communicate the audio to another loudspeaker. Selection between audio worn audio accessories or other speaker may be based on a state of the audio accessory, for example, whether an earbud is properly positioned inside a user's ear or not.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example audio device.

FIG. 2 illustrates an example audio system for detecting a device state.

FIG. 3 illustrates an example method for detecting a device state.

FIG. 4 illustrates a media device and an associated audio accessory.

FIG. 5 illustrates an isometric view of a housing for an in-ear earphone.

FIG. 6 schematically illustrates anatomy of a typical human ear.

FIG. 7 schematically illustrates an in-ear earphone positioned in the human ear shown in FIG. 6.

FIG. 8 illustrates a block diagram showing aspects of an audio appliance.

FIG. 9 illustrates a block diagram showing aspects of a computing environment.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Improved techniques are presented for determining the state of an audio device, including reduced power techniques for determining if an earbud is currently being worn in a user's ear or not. In aspects, a potential state change in an audio device may be detected, and in response, a state of the device may be determined. For example, in response to determining a potential state change, a measurement of the device state may be initiated, such as by emitting an audio signal and then determining the state of the audio device based on analysis of a sensed version of the emitted audio signal. In some cases, a variety of different lower-power techniques may be used to detect a potential state change, while a high-confidence measurement of the current device state may involve using comparatively more power than the detection of potential state change. By initiating the high-power measurement in response to low power detection of a potential change, a frequency of the higher-power process may be reduced, resulting in a lower average power requirements over time.

In aspects, a potential state change may be detected from of a variety of received signals, including emitting and analysis of a substantially monotone ultrasonic signal, detecting sufficient motion from a motion sensor, and/or analysis or ambient noise via more than one microphone. In other aspect, a high-confidence device state measurement may include analysis of an emitted ultrasonic signal with a variable tone such as a chirp.

FIG. 1 illustrates an example 100 audio device. Example 100 includes an audio device 102 in the environment of an ear 104. The device 102 may include an emitter 120, and one or more sensors. In example 100, device 102 includes a first, second and third sensors 122, 124, and 126. In aspects, device 102 may include a variety of different types of sensor. In the example 100, first sensor 122 may be a microphone positioned on a housing of device 102 at a location that may be inside a user's ear canal when in a worn state (such as an “error microphone” typically used for noise cancellation), while second sensor 124 may be positioned outside the ear when device 102 is in a worn state (such as a microphone for recording a wearer's voice). Third sensor 126 may be a motion sensor, such as an accelerometer or other type of inertial measurement unit (IMU). In an aspect, audio device 102 may be an audio accessory of a separate audio device (not depicted) such as a paired cell phone acting as a source or sink of a digital audio output stream (e.g., music).

Aspects of techniques disclosed herein may include detecting a potential change of state of device 102 relative to ear 104 and determining a static state. Detecting a potential change of state of device 102 may include detecting insertion 150 of device 102 into ear 104, removal 152 of device 102 out of ear 104, or movement into or out of an ear canal of ear 104. Determining a static state may include determining if an audio device is being worn or not, and determining a static state my include determining a quality of alignment or a quality of an acoustic coupling between an audio device 102 and ear 104.

In aspects, there may be many possible states of an audio device. For example, possible states of an audio device may include an in-ear state, a not-in-ear-state, an in-device-case state, a powered down state, an in-pocket state, etc. Techniques described herein for determining a states of an audio device may include choosing between only two such states, such as choosing between in-ear and not-in-ear, or may include choosing between more than two such states.

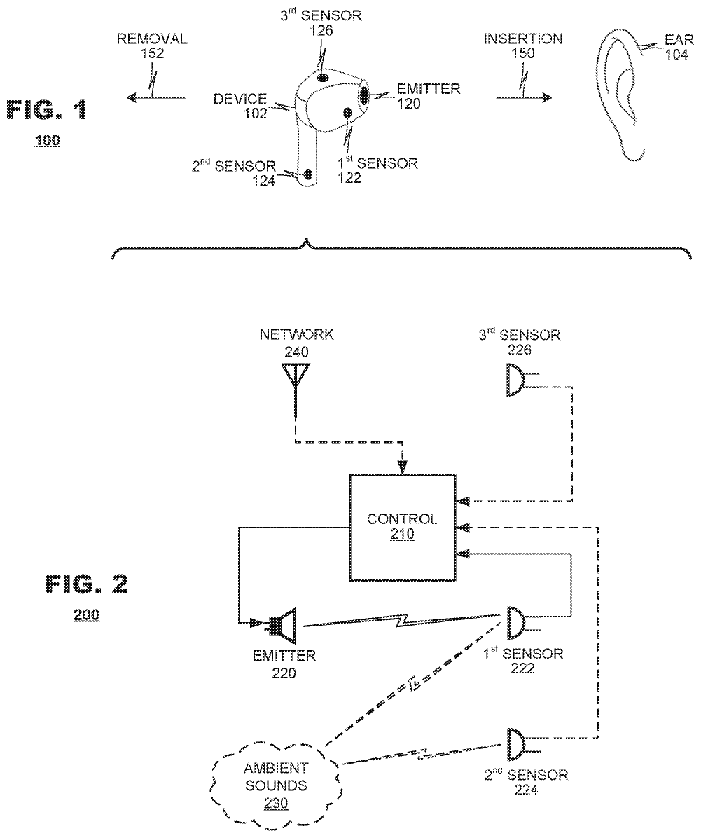

FIG. 2 illustrates an example audio system 200 for detecting a device state. Audio system 200 may be an example of audio device 102 of FIG. 1. Audio system 200 include an emitter 220, first sensor 222, and control unit 210. Optional aspects include second and third sensors 224, 226, network 240 (e.g., a wired or wireless network connection to an audio source such as a paired media device), and/or ambient sounds 230.

In operation, audio system 200 may determine a state of the system by first detecting a potential state change based on data from one or more of the sensors 222, 224, 226. In response to the potential state change detection, control unit 210 may initiate determining the state of the audio device. The state may be determined, for example, by causing a state-determination signal to be generated by emitter 220, and a sensed version of the state-determination signal may be received at a 1st sensor 222, such as an earbud's internal microphone. The state-determination signal may include an ultrasonic chirp or other inaudible sounds with variations in pitch or tone. A state of the device may then be determined by classification of the received version of the state-determination signal may include, for example, classification as in-ear (worn state), or free-field (non-worn state). When a state classification is indeterminate, a prior known state of the audio system 200 may be assumed or preserved. In an aspect, the classification of received version of the state-determination signal or other analysis of the state detection signal may be performed using a neural network or other types of signal analysis techniques in order to determine the state of the audio device.

In an aspect, the detection of a potential state change may include first emitting a change-in-state signal by emitter 220 (in addition to later emitting the state detection signal), and then receiving the change-in-state signal at one or more of the sensors of audio system 200. In an alternate aspect (not depicted), the change-in-state signal may be received at two separate sensors, such as first sensor 222 and second sensor 224, and a potential change in state may be determined based on a comparison of the two received versions of the change-in-state signal. In one aspect, the emitted change-in-state signal may include an inaudible tone, and in aspects may be emitted substantially continuously. In another aspect, the emitted change-in-state signal may include human-audible sounds, such as music received from a music source via network 240.

In other aspects for detecting the potential state change, the potential change in state may be determined by sensed audio that was not first emitted by an emitter of system 200. For example, a state change may be determined by comparing ambient sounds 230 received at two different sensors 222 and 224, such as where sensor 222 is a microphone internal to a user's ear canal) and sensor 224 is a microphone external to the user's ear canal. The ambient sounds sensor by the two different microphone may be compared to each other, and/or may be compared to prior recording of ambient sounds in order to determine a potential change in state of the audio device. In an aspect, a currently difference in an envelope of the ambient sounds may be compared to a difference in an envelope of prior ambient sounds, and when the change in difference is above a threshold, then a potential state change may be determined to have occurred between the sensing of the current ambient sounds and the sensing of the prior ambient sounds.

In yet another aspect, a potential state change may be detected from a variety of other types of sensors, such as a movement sensor (e.g., an accelerometer), a light sensor, or a sensor indicating a wireless network signal strength (e.g., Wi-Fi or Bluetooth). In an aspect, when a measurement from a one of these sensor is above a threshold, a potential state change is determined. For example, when movement of the device, which may be sensed as a movement signal from a movement sensor, is above a threshold, then a potential state change is detected and the state determination process may be initiated. When the movement is below the threshold, the potential state change is not detected and the state determination process may not be initiated.

Device 102 is depicted in FIG. 1 as a wireless earbud, such as an audio device that may be inserted into a portion of a user's ear canal. However, the techniques disclosed herein are not limited to an ear bud. For example, audio system 200 may be implemented as a wired audio device (e.g. with a physical wire connecting audio system 200 to an audio source), as a headset where a single a head-mounted structure include earpieces for both, and the earpieces may be shaped for in-ear, on-ear, or over-ear positioning including earpieces that do not insert into an ear canal.

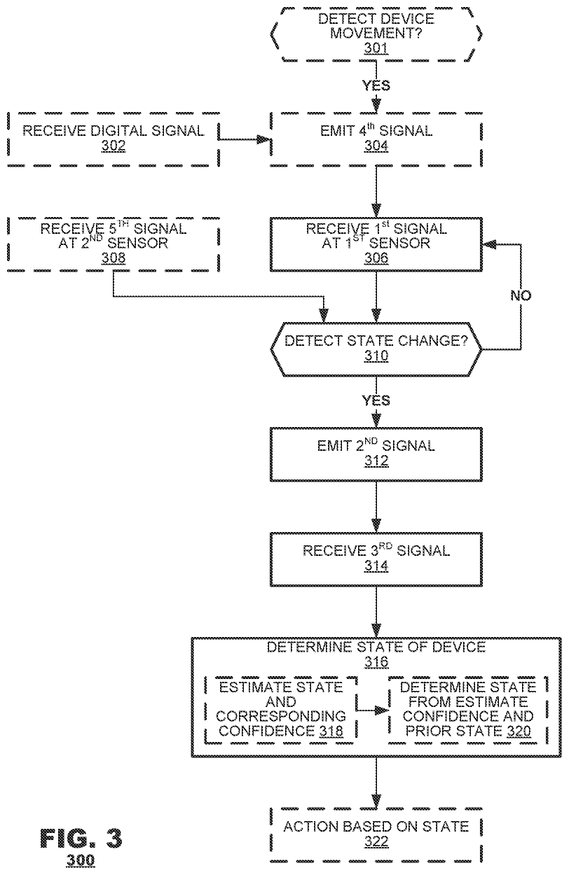

FIG. 3 illustrates an example method 300 for detecting a device state. In method 300, a change-in-state signal is received as a first signal at a first sensor (box 306). When a potential state change is detected, a state-determination signal is emitted as a second signal (box 312). A third signal is received (box 314) that includes a received version of at least a portion of the emitted state determination signal. A state of the device is determined (box 316) based on the third signal. As explained above regarding FIG. 2, in aspects, the change-in-state signal may include ambient sounds, a substantially monotone ultrasonic signal emitted by the device, and/or a signal from a non-audio sensor (such as a sensor for movement or light), while the state-determination signal may include an ultrasonic chip with variations in tone over time. In aspects, emitting and/or analysis of the change-in-state signal may require fewer resources (such as electrical power or computational complexity) as compared to emitting and/or analysis of the state-determination signal.

In an optional aspect of method 300, a fourth signal may be emitted (box 304), where the received first signal (box 306) includes a received version of at least a portion of the emitted fourth signal. In an aspect, the fourth signal may be an inaudible signal. An inaudible signal may include frequencies in the ultrasonic range, or may be another type of signal not generally audible to humans, such as certain tonary sequences, or a signal that is hidden by other ambient sounds. An emitted fourth signal may also include a maximum length sequence (MLS) signal. In other aspects, the fourth signal may also include human audible sounds, such as music.

In another aspect, the fourth signal may be emitted either periodically (for example, once per second) or substantially continuously. In some cases, it may only be emitted in certain device states, such as when the device is in a worn state, and not emitted when not in a worn state. In other aspects, the fourth signal may be emitted (box 304) in response to detecting movement of the device (box 301). For example, the fourth signal may be emitted (box 304) when movement above a threshold is detected from an accelerometer or an inertial measurement unit (IMU). In another optional aspect, the emitted 4^{th} signal may include a received digital signal (box 302) from a remote audio source, such from a paired cell phone or other audio device.

In another optional aspect, a fifth signal may be received at a second sensor (box 308), and the fifth signal may be used in combination with the first signal from the first sensor (box 306) in order to detect a state change (box 310). For example, the first and fifth signals may be compared to each other or to prior received signals. In an aspect, a change-in-state signal may be measured at both an internal microphone (positioned inside an ear canal when in a worn state, sometimes called an “error mic”) and at an external microphone (position outside the ear when in a worn state), and the two different received versions of the change-in-state signal (i.e. the received first signal in box 306 and received fifth signal in box 308) may be compared to determine a potential change in state (box 310). In this aspect the change-in-state signal may be received versions of the emitted 4^{th} signal (box 304) or may be ambient sound that is not emitted by the audio device. As further explained above regarding FIG. 2, a potential state change may be detected (box 310) based on a comparison of ambient sounds measured at both internal and external microphones.

In an aspect, a state change may be detected (box 310) based on analysis of the received first signal. For example, analysis of an envelope of a portion of the first signal may indicate movement of a wearable audio device is moving either toward or away from an ear of a user of the wearable audio device. In an aspect, the portion of the first audio signal indicating movement may include a version of an emitted fourth signal that has been reflected on a portion of an ear of the user of the wearable audio device.

In an aspect, the first signal and second signal may have different temporal characteristics. For example, the first signal may include a substantially continuous audio tone over time at one or more frequencies, while the second signal may include a discontinuous set of tones with at least two tones generated with different frequencies at different times.

In an aspect, determining the state of the device (box 316) may depend on a prior known state of the device when confidence of an estimate is low. A current state of the device may be estimated along with a corresponding confidence in the state estimate (optional box 318). For example, the estimate and corresponding confidence may be produced by analysis of the third signal by a neural network. Then a current state of the device may be determined based on the estimated current state and correspond confidence along with a predetermined prior state of the device. For example, when the confidence in the estimated current state is low (e.g., below a threshold), the current device state may be determined to be the predetermined prior device state, and when the confidence is high (e.g., above the threshold), the current device state is determined to be the currently estimated state.

In an optional aspect, an action may be taken based on the state of the device (box 322). For example, a paired device may be notified of a change in device state, which may then start an audio stream if the state transitions to a worn state, or conversely may stop an audio stream if the state transitions to an unworn state. In another example, the device may enter a low-power mode after a transition to an unworn state.

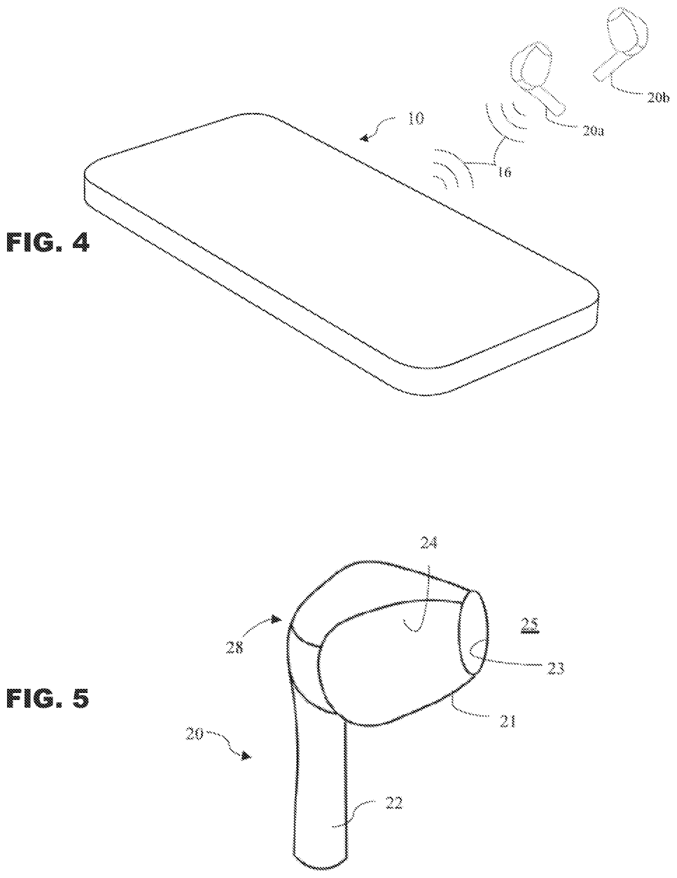

FIG. 4 shows a portable media device 10 suitable for use with a variety of accessory devices. In an aspect, method 300 of FIG. 3 may include determining the state of accessory device 20a and/or 20b (box 316), and the source of received digital signal (box 302) may be portable media device 10. The portable media device 10 may include, for example, a touch sensitive display configured to provide a touch sensitive user interface for controlling the portable media device 10 and in some aspects any accessories to which the portable media device 10 is electrically or wirelessly coupled. For example, the media device 10 can include a mechanical button, a tactile/haptic button, or variations thereof, or any other suitable ways for navigating on the device. The portable media device 10 can also include a communication connection, e.g., one or more hard-wired input/output (I/O) ports that can include a digital I/O port and/or an analog I/O port, or a wireless communication connection.

An accessory device can take the form of an audio device that includes two separate earbuds 20a and 20b. Each of the earbuds 20a and 20b can include wireless receivers, transmitters, or transceivers capable of establishing a wireless link 16 with the portable media device 10 and/or with each other. Alternatively and not shown in FIG. 4, the accessory device can take the form of a wired or tethered audio device that includes separate earbuds. Such wired earbuds can be electrically coupled to each other and/or to a connector plug by a number of wires. The connector plug can matingly engage with one or more of the I/O ports and establish a communication link over the wire and between the media device and the accessory. In some wired aspects, power and/or selected communications can be carried by the one or more wires and selected communications can be carried wirelessly.

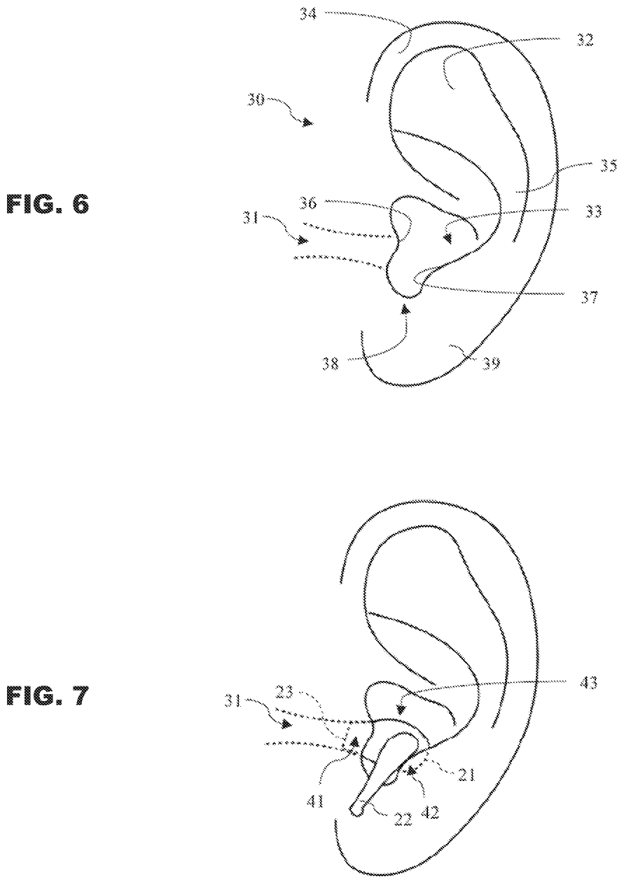

In as aspect, housing of earbud 20 as depicted in FIG. 5 may enable determination of a current device state (box 316 of FIG. 3). In another aspect, FIG. 6 may illustrate features of a human ear such as ear 104 (FIG. 1) and FIG. 7 may illustrate an earbud inserted into a human ear, such as device 102 after insertion 150 into ear 104 (FIG. 1).

FIG. 5 illustrates an isometric view of a housing for an in-ear earphone. FIG. 5 shows an earbud housing 20 configured to operatively engage with common anatomy of a human ear when being worn by a user, and FIG. 3 illustrates such ear anatomy 30 schematically. FIG. 5 shows the earbud housing 20 positioned within an ear 30 of a user during use. As depicted among FIGS. 5, 6 and 7, the earbud housing 20 defines a major medial surface 24 that faces the surface of the user's concha cavum 33 when the housing 20 is properly seated in a user's ear 30.

For example, when properly positioned in a user's ear 30, the earphone housing 20 can rest in the user's concha cavum 33 between the user's tragus 36 and anti-tragus 37, as in FIG. 4. An external surface of the housing, e.g., the major medial surface 24, can be complementarily contoured relative to, for example, the user's concha cavum 33 (or other anatomy) to provide a contact region 43 (FIG. 4) between the contoured external surface and the user's skin when the earphone is properly positioned. The contact region 43 can span a major portion of the contoured external surface 24. Those of ordinary skill in the art will understand and appreciate that, although the complementarily contoured external surface 24 is described in relation to the concha cavum 33, other external regions of an earphone housing 20 can be complementarily contoured relative to another region of a human ear 30. For example, the housing 20 defines a major bottom surface 21 that generally rests against the region of the user's ear between the anti-tragus 37 and the concha cavum 33 to define a contact region 42. Still other contact regions are possible.

The housing 20 also defines a major lateral surface 28 from which a post 22 extends. The post 22 can include a microphone transducer and/or other component(s) such as a battery. Alternatively, in context of a wired earbud, one or more wires can extend from the post 22. When the earbud is properly donned, as in FIG. 4, the post 22 extends generally parallel to a plane defined by the user's earlobe 39 at a position laterally outward of a gap 38 between the user's tragus 36 and anti-tragus 37.

Further, the earbud defines an acoustic port 23. The port 23 provides an acoustic pathway from an interior region of the housing 20 to an exterior 25 of the housing. As shown in FIG. 7, the port 23 aligns with and opens to the user's ear canal 31 when the earbud is properly donned as described above. A mesh, screen, film, or other protective barrier (not shown) can extend across the port 23 to inhibit or prevent intrusion of debris into the interior of the housing.

In some earbuds, the housing 20 defines a boss or other protrusion from which the port 23 opens. The boss or other protrusion can extend into the ear canal 31 and can contact the walls of the canal over a contact region 41. Alternatively, the boss or other protrusion can provide a structure to which a resiliently flexible cover (not shown) such as, for example, a silicone cover, can attach to provide an intermediate structure forming a sealing engagement between the walls of the user's ear canal 31 and the housing 20 over the contact region 41. The sealing engagement can enhance perceived sound quality, as by passively attenuating external noise and inhibiting a loss of sound power from the earbud.

Although not specifically shown, the housing 20 also can include a compliant member to conform to person-to-person variations in contour among the tragus 36, anti-tragus 37, and concha cavum 33. For example, a compliant member can matingly engage with a region of the housing 20 corresponding to the major surface 24. Such a compliant member (not shown) can accommodate a certain amount of compression that allows secure seating of housing 20 within the ear 30 of the user, e.g., within the concha cavum 33.

The housing 20 can be formed of any material or combination of materials suitable for earphones. For example, some housings are formed of acrylonitrile butadiene styrene (ABS). Other representative materials include polycarbonates, acrylics, methacrylates, epoxies, and the like. A compliant member can be formed of, for example, polymers of silicone, latex, and the like.

FIG. 7 also depicts several regions of contact between the earphone housing 20 and tissue of the user's ear 30. Each region 41, 42, 43 defines an area on the surface of the housing 20, or surface of an intermediate compliant member, that urges against the user's tissue.

Proximity sensor or portion thereof can be positioned within the housing 20 at a position opposite a selected contact region 41, 42, 43 relative to the housing wall. For example, a proximity sensor, or a transmitter and/or receiver thereof, can be positioned in the housing 20 opposite a contact region 41, 42, 43 (or other intended contact region) to define a corresponding sensitive region of the earphone housing. Each respective sensor can assess whether or to what extent the corresponding contact region 41, 42, 43, and thus the housing 20, is aligned in the user's ear.

Further, physical characteristics of a local environment can influence a degree to which an emitted signal may reflect and/or be damped as it passes through the environment. For example, ultrasonic energy may dissipate much more quickly through air or a textile (or other material having a high attenuation coefficient over a frequency range of interest) as compared to water or human tissue. In addition, a reflection of an emitted ultrasonic signal that passes through air or a textile may be much more attenuated when received by the receiver compared to a reflection of an ultrasonic signal that passes through water or human tissue. As well, a reflection of an emitted ultrasonic signal that passes through a dry interface between a given sensor and a given tissue may be much more attenuated when received by the receiver compared to a reflection of an ultrasonic signal that passes through an interface having an acoustic coupling between the sensor and the tissue. If the transducer is positioned to emit the signal into, for example, a user's tissue or other substance, the tissue or other substance can reflect the signal and the reflected signal can be received by the sensor or a component thereof. Accordingly, reflections received by the sensor can indicate when a user's tissue (e.g., a user's ear) is positioned in close proximity to the sensor. Some disclosed proximity sensors can detect characteristics of a local environment through a solid (e.g., non-perforated) housing wall to provide an uninterrupted external surface and an aesthetically pleasing appearance to the housing. Nonetheless, some housing walls may have a plurality of visibly indistinguishable perforations (sometimes referred to as “micro-perforations”).

Some earphones define a single sensitive region corresponding to one selected contact region. When the sensitive region is adjacent or immersed in air or a textile, for example, emitted ultrasonic signals may dissipate and reflections might not be received. Accordingly, the underlying proximity sensor can determine that the earbud is not being worn and can emit a corresponding signal to the media device 10. However, when the sensitive region is adjacent or in contact with, for example, a table or a shelf, the underlying proximity sensor may receive a reflection of an emitted ultrasonic signal and determine (in this example incorrectly) that the earbud is being worn.

To avoid a false indication that an earbud is being worn, some earphones incorporate a plurality of proximity sensors or transducers to define a corresponding plurality of sensitive regions on the earbud housing 20. The plurality of sensitive regions can be spaced apart from each other, for example, so no two sensitive regions can contact a flat surface (e.g., a shelf or a desk) when the earbud housing 20 rests on the flat surface. For example, if transducers are arranged to make the contact regions 41 and 43 sensitive, both contact regions will not simultaneously contact a flat surface on which the earbud housing 20 rests. Thus, both regions will not indicate the earbud is being worn when the earbud housing 20 rests on a flat surface. The underlying sensor can be configured to determine the earbud housing is being worn only when two or more of the sensitive regions receive reflected ultrasonic signals. Otherwise, the sensor can indicate that the earphone is not being worn.

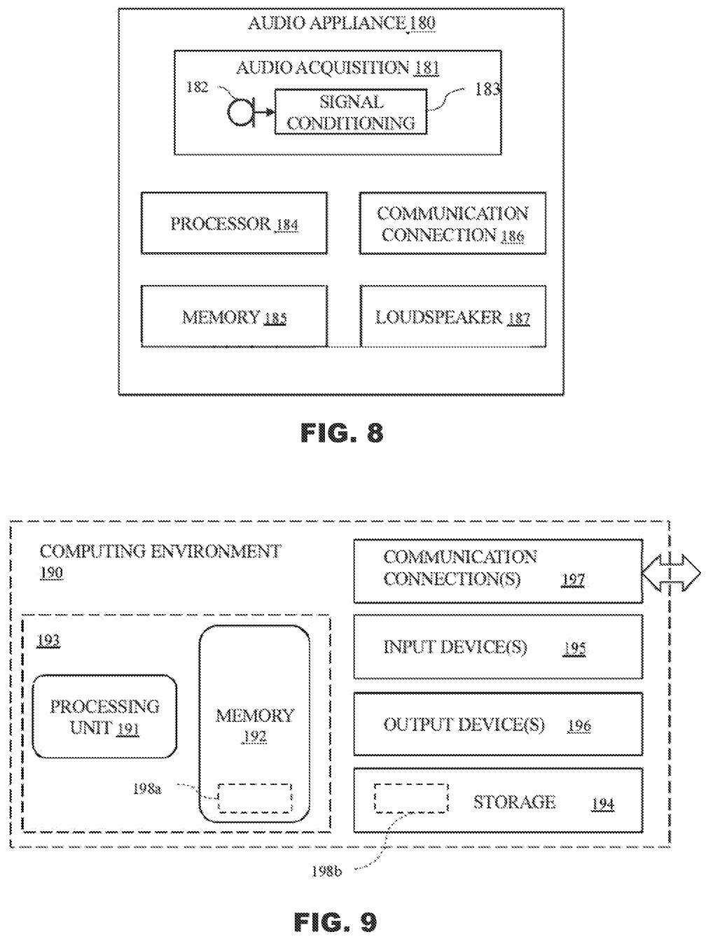

FIG. 8 illustrates a block diagram showing aspects of an audio appliance. In an aspect, audio appliance 180 of FIG. 8 may be an example of device 102 (FIG. 1) or audio system 200 (FIG. 2). FIG. 8 shows an example of a suitable architecture for an audio appliance (e.g., a media device 10, in FIG. 1). The audio appliance 180 includes an audio acquisition module 181 and aspects of a computing environment (e.g., described more fully below in connection with FIG. 19) that can cause the appliance to communicate with an audio accessory in a defined manner. For example, the illustrated appliance 180 includes a processing unit 184 and a memory 185 that contains instructions the processing unit can execute to cause the audio appliance to, e.g., carry out one or more aspects of receiving an output from an ultrasonic proximity sensor and/or responding to an indication of an environment in which audio device 102 (FIG. 1) or audio accessory 20a, 20b (FIG. 4) is positioned.

Referring still to FIG. 8, an audio appliance typically includes a microphone transducer to convert incident acoustic signals to corresponding electrical output. As used herein, the terms “microphone” and “microphone transducer” are used interchangeably and mean an acoustic-to-electric transducer or sensor that converts an incident acoustic signal, or sound, into a corresponding electrical signal representative of the incident acoustic signal. Typically, the electrical signal output by the microphone is an analog signal.

Although a single microphone is depicted in FIG. 8, this disclosure contemplates the use of plural microphones. For example, plural microphones can be used to obtain plural distinct acoustic signals emanating from a given acoustic scene, and the plural versions can be processed independently and/or combined with one or more other versions before further processing by the audio appliance 180.

As shown in FIG. 8, the audio acquisition module 21 can include a microphone transducer 182 and a signal conditioner 183 to filter or otherwise condition the acquired representation of ambient sound. Some audio appliances have an analog microphone transducer and a pre-amplifier to condition the signal from the microphone.

As shown in FIG. 8, an audio appliance 180 or other electronic device can include, in its most basic form, a processor 184, a memory 185, and a loudspeaker or other electro-acoustic transducer 187, and associated circuitry (e.g., a signal bus, which is omitted from FIG. 8 for clarity).

The audio appliance 180 schematically illustrated in FIG. 8 also includes a communication connection 186, as to establish communication with another computing environment, audio device 102 (FIG. 1), or an audio accessory, such as accessory 20a, 20b (FIG. 1). The memory 185 can store instructions that, when executed by the processor 184, cause the circuity in the audio appliance 180 to drive the electro-acoustic transducer 187 to emit sound over a selected frequency bandwidth or to communicate an audio signal over the communication connection 186 to an audio accessory 20a, 20b for playback. In addition, the memory 185 can store other instructions that, when executed by the processor, cause the audio appliance 180 to perform any of a variety of tasks akin to a general computing environment as described more fully below in connection with FIG. 9.

FIG. 9 illustrates a block diagram showing aspects of a computing environment. FIG. 9 illustrates a generalized example of a suitable computing environment 190 in which described methods, embodiments, techniques, and technologies relating, for example, to assessing a local environment for the computing environment or an accessory thereto can be implemented. The computing environment 190 is not intended to suggest any limitation as to scope of use or functionality of the technologies disclosed herein, as each technology may be implemented in diverse general-purpose or special-purpose computing environments, including within an audio appliance. For example, each disclosed technology may be implemented with other computer system configurations, including wearable and/or handheld appliances (e.g., a mobile-communications device, such as, for example, IPHONE®/IPAD®/AIRPODS®/HOMEPOD™ devices, available from Apple Inc. of Cupertino, CA.), multiprocessor systems, microprocessor-based or programmable consumer electronics, embedded platforms, network computers, minicomputers, mainframe computers, smartphones, tablet computers, data centers, audio appliances, and the like. Each disclosed technology may also be practiced in distributed computing environments where tasks are performed by remote processing devices that are linked through a communications connection or network. In a distributed computing environment, program modules may be located in both local and remote memory storage devices.

The computing environment 190 includes at least one central processing unit 191 and a memory 192. In FIG. 9, this most basic configuration 193 is included within a dashed line. The central processing unit 191 executes computer-executable instructions and may be a real or a virtual processor. In a multi-processing system, or in a multi-core central processing unit, multiple processing units execute computer-executable instructions (e.g., threads) to increase processing speed and as such, multiple processors can run simultaneously, despite the processing unit 191 being represented by a single functional block.

A processing unit, or processor, can include an application specific integrated circuit (ASIC), a general-purpose microprocessor, a field-programmable gate array (FPGA), a digital signal controller, or a set of hardware logic structures (e.g., filters, arithmetic logic units, and dedicated state machines) arranged to process instructions.

The memory 192 may be volatile memory (e.g., registers, cache, RAM), non-volatile memory (e.g., ROM, EEPROM, flash memory, etc.), or some combination of the two. The memory 192 stores instructions for software 198a that can, for example, implement one or more of the technologies described herein, when executed by a processor. Disclosed technologies can be embodied in software, firmware or hardware (e.g., an ASIC).

A computing environment may have additional features. For example, the computing environment 190 includes store 194, one or more input devices 195, one or more output devices 196, and one or more communication connections 197. An interconnection mechanism (not shown) such as a bus, a controller, or a network, can interconnect the components of the computing environment 190. Typically, operating system software (not shown) provides an operating environment for other software executing in the computing environment 190, and coordinates activities of the components of the computing environment 190.

The store 194 may be removable or non-removable, and can include selected forms of machine-readable media. In general, machine-readable media includes magnetic disks, magnetic tapes or cassettes, non-volatile solid-state memory, CD-ROMs, CD-RWs, DVDs, magnetic tape, optical data storage devices, and carrier waves, or any other machine-readable medium which can be used to store information, and which can be accessed within the computing environment 190. The store 194 can store instructions for the software 198b that can, for example, implement technologies described herein, when executed by a processor.

The store 194 can also be distributed, e.g., over a network so that software instructions are stored and executed in a distributed fashion. In other aspects, e.g., in which the store 194, or a portion thereof, is embodied as an arrangement of hardwired logic structures, some (or all) of these operations can be performed by specific hardware components that contain the hardwired logic structures. The store 194 can further be distributed, as between or among machine-readable media and selected arrangements of hardwired logic structures. Processing operations disclosed herein can be performed by any combination of programmed data processing components and hardwired circuit, or logic, components.

The input device(s) 195 may be any one or more of the following: a touch input device, such as a keyboard, keypad, mouse, pen, touchscreen, touch pad, or trackball; a voice input device, such as one or more microphone transducers, speech-recognition technologies and processors, and combinations thereof; a scanning device; or another device, that provides input to the computing environment 190. For audio, the input device(s) 195 may include a microphone or other transducer (e.g., a sound card or similar device that accepts audio input in analog or digital form), or a computer-readable media reader that provides audio samples and/or machine-readable transcriptions thereof to the computing environment 190.

The output device(s) 196 may be any one or more of a display, printer, loudspeaker transducer, DVD-writer, signal transmitter, or another device that provides output from the computing environment 190, e.g., an audio accessory 20a, 20b (FIG. 1). An output device can include or be embodied as a communication connection 197.

The communication connection(s) 197 enable communication over or through a communication medium (e.g., a connecting network) to another computing entity or accessory. A communication connection can include a transmitter and a receiver suitable for communicating over a local area network (LAN), a wide area network (WAN) connection, or both. LAN and WAN connections can be facilitated by a wired connection or a wireless connection. If a LAN or a WAN connection is wireless, the communication connection can include one or more antennas or antenna arrays. The communication medium conveys information such as computer-executable instructions, compressed graphics information, processed signal information (including processed audio signals), or other data in a modulated data signal. Examples of communication media for so-called wired connections include fiber-optic cables and copper wires. Communication media for wireless communications can include electromagnetic radiation within one or more selected frequency bands.

Machine-readable media are any available media that can be accessed within a computing environment 190. By way of example, and not limitation, with the computing environment 190, machine-readable media include memory 192, store 194, communication media (not shown), and combinations of any of the above. Tangible machine-readable (or computer-readable) media exclude transitory signals.

As explained above, some disclosed principles can be embodied in a store 194. Such a store can include tangible, non-transitory machine-readable medium (such as microelectronic memory) having stored thereon or therein instructions. The instructions can program one or more data processing components (generically referred to here as a “processor”) to perform one or more processing operations described herein, including estimating, computing, calculating, measuring, adjusting, sensing, measuring, filtering, correlating, and decision making, as well as, by way of example, addition, subtraction, inversion, and comparison. In some aspects, some or all of these operations (of a machine process) can be performed by specific electronic hardware components that contain hardwired logic (e.g., dedicated digital filter blocks). Those operations can alternatively be performed by any combination of programmed data processing components and fixed, or hardwired, circuit components.

The examples described above generally concern ultrasonic proximity sensors, and related systems and methods. The previous description is provided to enable a person skilled in the art to make or use the disclosed principles. Aspects other than those described above in detail are contemplated based on the principles disclosed herein, together with any attendant changes in configurations of the respective apparatus described herein, without departing from the spirit or scope of this disclosure. Various modifications to the examples described herein will be readily apparent to those skilled in the art.

For example, an earbud can also be equipped with various other sensors that can work independently or in concert with the proximity sensor described herein. For example, in some aspects, the other sensors can take the form of an orientation sensor to help the earbud determine which ear the earbud is positioned within and then adjust operation of the earbud in accordance with that determination. In some aspects, the orientation sensor can be a traditional inertial-based sensor while in other aspects, sensor readings from another biometric sensor such as a proximity sensor or a temperature sensor can be used to make an orientation determination.

An earbud with the aforementioned sensors can also include additional sensors such as a microphone or array of microphones. In some aspects, at least two microphones from a microphone array can be arranged along a line pointed towards or at least near the mouth of a user. By using information received by the orientation sensor or sensors, a controller within the earbud can determine which microphones of a microphone array should be activated to obtain this configuration. By activating only those microphones arranged along a vector pointed at or near the mouth, ambient audio signals not originating near the mouth can be ignored by applying a spatial filtering process.

Directions and other relative references (e.g., up, down, top, bottom, left, right, rearward, forward, etc.) may be used to facilitate discussion of the drawings and principles herein, but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated aspects. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” and “or.” Moreover, all patent and non-patent literature cited herein is hereby incorporated by reference in its entirety for all purposes.

And, those of ordinary skill in the art will appreciate that the exemplary aspects disclosed herein can be adapted to various configurations and/or uses without departing from the disclosed principles. Applying the principles disclosed herein, it is possible to provide a wide variety of damped acoustic enclosures, and related methods and systems. For example, the principles described above in connection with any particular example can be combined with the principles described in connection with another example described herein. Thus, all structural and functional equivalents to the features and method acts of the various aspects described throughout the disclosure that are known or later come to be known to those of ordinary skill in the art are intended to be encompassed by the principles described and the features claimed herein. Accordingly, neither the claims nor this detailed description shall be construed in a limiting sense, and following a review of this disclosure, those of ordinary skill in the art will appreciate the wide variety of ultrasonic proximity sensors, and related methods and systems that can be devised under disclosed and claimed concepts.

Moreover, nothing disclosed herein is intended to be dedicated to the public regardless of whether such disclosure is explicitly recited in the claims. No claim feature is to be construed under the provisions of 35 USC 112(f), unless the feature is expressly recited using the phrase “means for” or “step for”.

The appended claims are not intended to be limited to the embodiments shown herein, but are to be accorded the full scope consistent with the language of the claims, wherein reference to a feature in the singular, such as by use of the article “a” or “an” is not intended to mean “one and only one” unless specifically so stated, but rather “one or more”. Further, in view of the many possible embodiments to which the disclosed principles can be applied, I reserve to the right to claim any and all combinations of features and technologies described herein as understood by a person of ordinary skill in the art, including, for example, all that comes within the scope and spirit of the following claims.

What is claimed is:

1. A method, comprising:
receiving, via first sensor of a wearable audio device, a first audio signal;
detecting, based the first audio signal, a potential state change for the wearable audio device;
emitting, by the wearable audio device and responsive to detecting the potential state change, a second audio signal;
receiving, via the first sensor of the wearable audio device, a third audio signal including a sensed version of the emitted second audio signal; and
determining, by the wearable audio device, a current state of the wearable audio device based on the third audio signal.

2. The method of claim 1, further comprising:
emitting, by the wearable audio device, a fourth audio signal;
wherein the fourth audio signal is inaudible, and the first audio signal includes a sensed version of the emitted fourth audio signal.

3. The method of claim 2, further comprising:
detecting, by a movement sensor of the wearable audio device, motion of the wearable audio device above a threshold;
wherein the fourth audio signal is emitted in response to the detecting of the motion above the threshold.

4. The method of claim 1, wherein the first audio signal includes an ambient noise around the wearable audio device, and the method further comprising:
receiving, at a second sensor of the wearable audio device, a fifth audio signal including the ambient noise;
wherein the detecting the potential state change is based on a comparison between the first audio signal and the fifth audio signal.

5. The method of claim 1, wherein the first audio signal includes music, and the method further comprises:
receiving, at the wearable audio device, a digital version of the music from a music source; and
emitting, by the wearable audio device, a fourth audio signal based on the digital version of the music.

6. The method of claim 1, wherein the detecting the potential state change is further based on one or more of: an ambient noise sensed at the wearable audio device, a received signal strength indicator (RS SI) of a Bluetooth signal, and an optical sensor of the wearable audio device.

7. The method of claim 1, wherein the first audio signal has a first temporal characteristic that is different from a second temporal characteristic of the second audio signal.

8. The method of claim 1, wherein the first temporal characteristic comprises a substantially continuous tone at one or more frequencies that are constant over time during the substantially continuous tone, and wherein the second temporal characteristic comprises a discontinuous set of tones that includes at least two tones generated with different frequencies and at different times.

9. The method of claim 1, wherein detecting the potential state change comprises detecting, based on an envelope of a portion of the first audio signal, a movement of the wearable audio device toward or away from an ear of a user of the wearable audio device.

10. The method of claim 9, further comprising:
emitting, by the wearable audio device, a fourth audio signal;
wherein the first audio signal includes the portion of the first audio signal comprises a version of the fourth audio signal reflected from a portion of an ear of a user of the wearable audio device.

11. The method of claim 9, wherein detecting the movement of the wearable audio device toward or away from an ear of a user of the wearable audio device comprises detecting the movement of the wearable audio device into the ear of the user, and wherein determining the current state of the wearable audio device based on the third audio signal comprises determining that the wearable audio device is in a worn state based on a reflected portion of the third audio signal corresponding to a version of the second audio signal reflected from one or more features of the ear of the user.

12. The method of claim 9, wherein detecting the movement of the wearable audio device toward or away from an ear of a user of the wearable audio device comprises detecting the movement of the wearable audio device out of the ear of the user, and wherein determining the current state of the wearable audio device based on the third audio signal comprises determining that the wearable audio device is in a unworn state based on an unreflected portion of the second audio signal corresponding to a version of the second audio signal not reflected from one or more features of the ear of the user.

13. The method of claim 1, wherein determining the current state of the wearable audio device based on the third audio signal comprises:
determining, based on the third audio signal, that a new state of the wearable audio device cannot be determined from the third audio signal; and
maintaining the current state of the wearable audio device in a previous state of the wearable audio device.

14. A system comprising:
a processor; and
a memory storing instructions that when executed by the processor cause the system to:
receive, via first sensor of a wearable audio device, a first audio signal;
detect based the first audio signal, a potential state change for the wearable audio device;
emit, by the wearable audio device and responsive to detecting the potential state change, a second audio signal;
receive, via the first sensor of the wearable audio device, a third audio signal including a sensed version of the emitted second audio signal; and
determine, by the wearable audio device, a current state of the wearable audio device based on the third audio signal.

15. The system of claim 14, wherein the instructions further cause the system to:
emit, by the wearable audio device, a fourth audio signal;
wherein the fourth audio signal is inaudible, and the first audio signal includes a sensed version of the emitted fourth audio signal.

16. The system of claim 15, wherein the instructions further cause the system to:
detect, by a movement sensor of the wearable audio device, motion of the wearable audio device above a threshold;
wherein the fourth audio signal is emitted in response to the detecting of the motion above the threshold.

17. The system of claim 14, wherein the first audio signal includes an ambient noise around the wearable audio device, and the instructions further cause the system to:
receive, at a second sensor of the wearable audio device, a fifth audio signal including the ambient noise;
wherein the detection of the potential state change is based on a comparison between the first audio signal and the fifth audio signal.

18. A non-transitory computer readable medium comprising instructions that, when executed by a processor, cause the processor to:
receive, via first sensor of a wearable audio device, a first audio signal;
detect based the first audio signal, a potential state change for the wearable audio device;
emit, by the wearable audio device and responsive to detecting the potential state change, a second audio signal;
receive, via the first sensor of the wearable audio device, a third audio signal including a sensed version of the emitted second audio signal; and
determine, by the wearable audio device, a current state of the wearable audio device based on the third audio signal.

19. The medium of claim 18, wherein the instructions further cause the processor to:
emit, by the wearable audio device, a fourth audio signal;
wherein the fourth audio signal is inaudible, and the first audio signal includes a sensed version of the emitted fourth audio signal.

20. The medium of claim 19, wherein the instructions further cause the processor to:
detect, by a movement sensor of the wearable audio device, motion of the wearable audio device above a threshold;
wherein the fourth audio signal is emitted in response to the detecting of the motion above the threshold.
